(19) United States
(12) Patent Application Publication
(10) Pub. No.: US 2005/0226474 A1
(43) Pub. Date: Oct. 13, 2005

(54) Touchless biometric recognition

(75) Inventors: Peter-Michael Merbach, Zella-Mehlis (DE); Rudolf Hauke, Niederstotzingen (DE); Peter Maschotta, Eisfeld (DE)

Correspondence Address: DAVIDSON, DAVIDSON & KAPPEL, LLC, 485 SEVENTH AVENUE, 14TH FLOOR, NEW YORK, NY, 10018, US

(73) Assignee: TBS Holding AG, Switzerland (CH)

(21) Appl. No.: 10/509,448

(22) PCT Filed: Oct. 8, 2003
(86) PCT No.: PCT/DE03/03350

§ 371 Date: Sep. 28, 2004

(51) Int. Cl. G06K 9/00

(52) U.S. Cl. 382/124

(57) ABSTRACT

1. Touchless biometric recognition

2.1 The invention is underlied by the problem to specify a method of the type initially mentioned, with which an improved touchless biometric recognition is possible cheaply.

2.2 According to the invention, the problem is solved by mutually carrying out the observing, checking and/or correcting using the imaging facilities respectively and thereby acquiring position, attitude and degree of rotation.

2.3 The invention relates to a method for touchless recognition of biometric attributes of a body part, in particular of finger lines, comprising optical imaging from different points of view by several imaging facilities, observing and/or checking the position and/or the attitude of the body part to be recognized and/or correcting the images of the imaging facilities regarding the position and/or the attitude, wherein the shape of the body part is used.

The invention relates to a method for touchless recognition of biometric attributes of a body part, in particular of finger lines, comprising optical imaging from different points of view by several imaging facilities, observing and/or checking the position and/or the attitude of the body part to be recognized and/or correcting the images of the imaging facilities regarding the position and/or the attitude, wherein the shape of the body part is used.

In manifold applications, security systems are applied to refuse access to certain areas to unauthorized persons. Such areas are, for example, cash terminals, laboratory rooms to be kept secret and the like. These systems mainly use facilities for recognition of fingerprints and faces.

There are substantial attempts to overcome these systems. To increase the security, additional means are used, with which it is verified if it is the matter of a vital object.

In German Patent Document No. DE 101 23 561 A1, a method for identifying persons by means of biometric attributes of the finger tip is described, wherein both the shape of the finger tip and the fingerprint structures contained on the bottom side of the finger, including their spatial position and orientation on the finger tip, are detected as personal parameters by using images from different points of view by several cameras to create a three-dimensional profile of the finger tip and its dermal ridge structure. Thereby, the position and the rotation of the finger can be determined by means of an additional camera in front of the finger tip in order to ask the user for a correction of the position or to enhance the recognition analysis by the additional information of the degree of rotation of the finger.

In this method, the need of an additional camera for checking the position is disadvantageous, because the imaging facilities are the most expensive parts of an optical recognition apparatus.

The invention is underlied by the problem to specify a method of the type initially mentioned, with which an improved touchless biometric recognition is possible cheaply.

According to the invention, the problem is solved by a method comprising the attributes given in claim 1.

Advantageous embodiments are given in the dependent claims.

The advantage of the method according to the invention is that only a least possible number of imaging facilities is needed for the imaging from different directions, which fulfill two tasks at once and are therefore exploited more efficiently.

An improved recognition is possible by using the finger image or the finger model respectively across several phalanxes.

By measuring the respectively imaged nail surface, a simple and fast measurement of the degree of rotation of the finger is possible.

In the following, the invention is further explained considering examples of embodiments.

On this, it is shown by:

a schematic illustration of an arrangement for use with the method according to the invention.

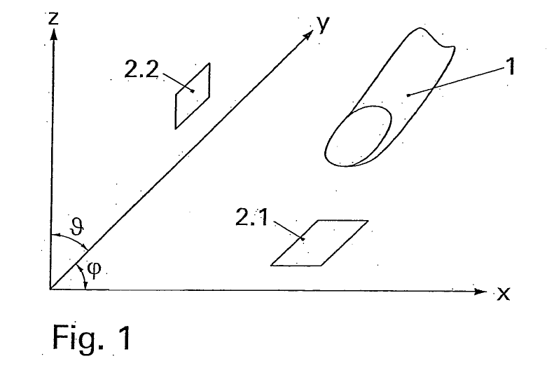

In FIG. 1, the two CCD cameras 2.1 and 2.2 exhibit an angle of 90° with respect to each other and are located in the planes separated by the angles [symbol] and φ in a coordinate system x-y-z while taking images of the object 1.

In a recognition attempt, both cameras are taking images repeatedly until both cameras determine a finger position acceptable for the other camera respectively. This condition can be satisfied either for both cameras simultaneously or temporally one after the other.

The same statement is valid for arrangements with more than two cameras. Then, the acceptances can be checked either pairwise or for a certain camera by a group or all of the other cameras respectively.

Two-dimensional images from certain points of view or three-dimensional models from the measurement data can be used as a reference and as a representation of the measurement data.

From the attitude, i.e., position, bending, degree of rotation, of the finger, a calculational transformation of the images to a finger in a “normal attitude” is possible, i.e., for example, in elongated attitude without twist, which is preferably also present in the reference images and reference models.

Thereby, the attributes of the finger's phalanxes and of the finger nail, i.e. thickness, width, length, are preferably also used in addition to the finger lines.

The degree of rotation of the finger can be calculated very easily from the nail surface respectively visible in the images.

The range of acceptance is clearly enhanced by the transformation to a “normal attitude”, whereby the procedure is carried out essentially faster.

On the other hand, a feedback to the user can be given as long as a deviation of the position and/or attitude too large for a secure recognition is present, wherein the type and direction of the necessary change in position or attitude can be announced or displayed.

Alternatively or additionally, a feedback can be given as soon as the recognition has been carried out successfully to inform the user about the end of the procedure.

### LIST OF REFERENCE NUMBERS

1 Object (finger)

2 Light detectors

3 First light detector in plane xy

4 Second light detector in plane zy

[symbol] , φ Angles of the coordinate system

1-8. (canceled)

9. A method for touchless recognition of at least one biometric attribute of a body part comprising:
capturing a plurality of first optical images of the body part from a first point of view using a first imaging device;
capturing a plurality of second optical images of the body part from a second point of view using a second imaging device;
monitoring and/or checking at least one of an attitude and a position of the body part; and
correcting, where necessary, at least one of the plurality of first images and the plurality of second images with reference to the attitude or position using a shape of the body part, wherein at least one of the observing and correcting is performed using an interaction between the first and second imaging devices so as to determine a desired position, attitude and angle of rotation.

10. The method as recited in claim 9, wherein the body part is a finger.

11. The method as recited in claim 10, wherein the at least one biometric attribute includes a finger line pattern.

12. The method as recited in claim 9, further comprising creating a spatial, three-dimensional profile of the body part.

13. The method as recited in claim 12 wherein the three-dimensional profile includes a profile of a surface of the body part.

14. The method as recited in claim 9, wherein the image sharpness is used as a criterion for reaching the desired position.

15. The method as recited in claim 9, further comprising applying a transformation of the at least one biometric attribute of the body part to a predetermined normal attitude and normal position of one of a reference model and a reference image using measured values of the position and/or the attitude

16. The method as recited in claim 15, further comprising providing at least one of an optical and an acoustical feedback when a secure recognition is not possible despite the calculational transformation.

17. The method as recited in claim 16, wherein the feedback includes an indication of a type and direction of a change of attitude and/or position required for a secure recognition.

18. The method as recited in claim 11, wherein the finger and its shape are imaged and processed from the tip of the finger to at least beyond the adjacent joint and wherein at least one angle of the joint is used for the observing, the checking and/or the correcting of the images.

19. The method as recited in claim 11, further comprising using the fingernail surface visible from the different points of view for determining the degree of rotation.
